(19) United States
(12) Patent Application Publication
(10) Pub. No.: US 2010/0055532 A1
(43) Pub. Date: Mar. 4, 2010

(54) GAS DIFFUSION LAYER, FUEL CELL AND METHOD FOR FABRICATING FUEL CELL

(75) Inventors: Yuji Sasaki, Kanagawa-ken (JP); Yasutada Nakagawa, Kanagawa-ken (JP); Yuichi Yoshida, Ibaraki-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/550,943

(22) Filed: Aug. 31, 2009

(30) Foreign Application Priority Data
Sep. 3, 2008 (JP) 2008-226388

(51) Int. Cl. H01M 8/10; B01D 53/22; B05D 5/12

(52) U.S. Cl. 429/30; 96/9; 427/115

(57) ABSTRACT

According to an aspect of the invention, there is provided, a gas diffusion layer, including, base materials integrated being including in the gas diffusion layer configured in an air electrode, wettability of a surface of each base material changing in an integrated direction.

### CROSS REFERENCE TO RELATED APPLICATION

This application is based upon and claims the benefit of priority from the prior Japanese Patent Application No. JP2008-226388, filed Sep. 3, 2008; the entire contents of which are incorporated herein by reference.

### FIELD OF THE INVENTION

The present invention relates to a gas diffusion layer, a fuel cell and a method for fabricating the fuel cell.

### DESCRIPTION OF THE BACKGROUND

Recently, downsizing, portable and high performance on electronic devices has been developed with accompanying progress of electronics. Therefore, a cell having downsizing and high energy, which is used in electronic devices, has been highly demanded. In those situations, a fuel cell being not only small and light but high capacitance has been noticed. Especially, a direct methanol fuel cell (DMFC) using methanol as a fuel is suitable for downsizing as compared to a fuel cell using hydrogen gas. It is not necessary for the DMFC to difficult usage of hydrogen gas and an apparatus for forming hydrogen gas by modification of an organic fuel.

In the DMFC, a fuel electrode (anode electrode), a polymer solid electrolyte film, air electrode (cathode electrode) are configured in order and next to each other to constitute a film-electrode junction body. Further, methanol is provided at a fuel electrode side and reacts with H₂O on a catalyst layer near the polymer solid electrolyte film to generate protons (H⁺) and electrons (e⁻).

The gas diffusion layer is formed on surfaces of the air electrode, the fuel electrode and the catalyst layer. The gas diffusion layer configured with the air electrode side acts as uniformly providing oxygen with the catalyst layer of the air electrode side and controlling permeation of H₂O generated at the catalyst layer of the air electrode side.

Further, H₂O generated at the catalyst layer of the air electrode side permeates to the gas diffusion layer of the air electrode side to be gas-liquid equilibrium in the gas diffusion layer, which means coexistence between the water being liquid and vapor being gas. When H₂O contained in the gas diffusion layer of the air electrode side is excess, the holes in the gas diffusion layer of the air electrode side are infill so that permeation of oxygen as an oxidization agent may be blocked. Therefore, the gas diffusion layer of the air electrode side is desired to have a property to exhaust H₂O vapor, more specifically, transpiration property.

on the other hand, the H₂O permeated in the gas diffusion layer of the air electrode side permeates into the polymer solid electrolyte film to attain the catalyst layer of the fuel electrode side. Further, permeated H₂O reacts with the methanol at the catalyst layer of the fuel electrode side to generate protons and electrons. When the H₂O exhausted from the gas diffusion layer of the air electrode side is excess, an H₂O mount attained to the catalyst layer of the fuel electrode side is shortage so that generation of protons and electrons may be blocked. Therefore, the gas diffusion layer of the air electrode side is desired to have a property to control H₂O vapor, more specifically, humidity-retention property.

Therefore, a gas diffusion layer has been proposed in consideration with transpiration property and humidity-retention property. Japanese Patent Publication (Kokai) No. 2001-338655 discloses that a gas diffusion layer in an air electrode side is constituted with a first layer and a second layer, the second layer being thicker than the first layer, average hole-diameter of holes of the second layer being larger than average hole-diameter of holes of the first layer. Further, slurry mixed with carbon particles and PTFE dispersions are used in forming the first layer and the second layer. The mix ratio is the same. The technique disclosed in Japanese Patent Publication (Kokai) No. 2001-338655 sets a material property of the first layer and the second layer being equivalent and retains transpiration property and humidity-retention property by changing the average hole-diameter and a thickness of the hole. However, it may be difficult to retain suitable transpiration property and humidity-retention property by changing the average hole-diameter and the thickness of the hole. Furthermore, the transpiration property and the humidity-retention property may be instable.

### SUMMARY OF THE INVENTION

According to an aspect of the invention, there is provided, a gas diffusion layer, including, base materials integrated being including in the gas diffusion layer configured in an air electrode, wettability of a surface of each base material changing in an integrated direction.

Further, another aspect of the invention, there is provided, a fuel cell, including, a fuel cell electrode provided a fuel, an air electrode provided an oxidization agent, the air electrode including a gas diffusion layer, the gas diffusion layer including base materials integrated, wettability of a surface of each base material changing in an integrated direction, and a polymer solid electrolyte film sandwiched between the fuel cell electrode and the air electrode.

Further, another aspect of the invention, there is provided, a method for fabricating a fuel cell, including, dispersing base materials in a solvent with water and alcohol-group including a water-repellent material to generate a mixed solution, and coating the mixed solution on a catalyst layer and drying the mixed solution to form a gas diffusion layer, wherein wettability of a surface of each base material in a thickness direction is changed by changing an amount of the water-repellent material.

### BRIEF DESCRIPTION OF THE DRAWINGS

FIG. 1 is a schematic diagram showing an example of a gas diffusion layer according to a first embodiment of the present invention;

FIG. 2 is a schematic diagram showing an example of a gas diffusion layer according to a second embodiment of the present invention;

FIGS. 3A-3B are schematic diagrams showing examples of controlling transpiration property and humidity-retention property by combination with wettability and gas permeability according to the second embodiment of the present invention;

FIG. 4 is a schematic diagram showing an example of a fuel cell according to the third embodiment of the present invention;

FIG. 5 is a flowchart of a method for fabricating a fuel cell according to the fourth embodiment of the present invention.

### DETAILED DESCRIPTION OF THE INVENTION

### First Embodiment

Embodiments of the present invention will be described below in detail with reference to the drawing mentioned above. It is to be noted that the same or similar reference numerals are applied to the same or similar parts and elements throughout the drawings, and the description of the same or similar parts and elements will be omitted or simplified.

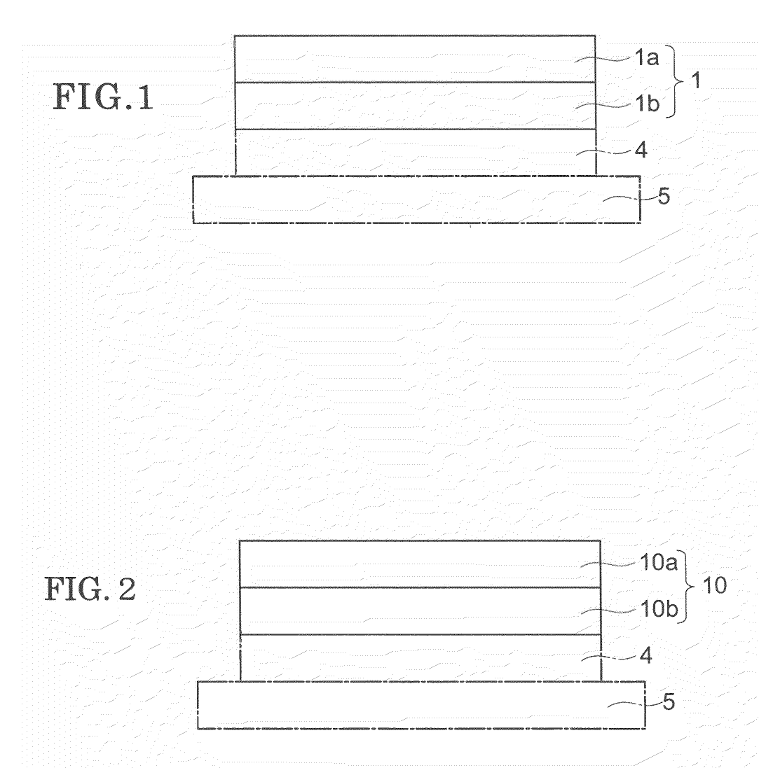

FIG. 1 is a schematic diagram showing an example of a gas diffusion layer according to a first embodiment of the present invention. First, transpiration property and humidity-retention property of a gas diffusion layer 1 are demonstrated as the example.

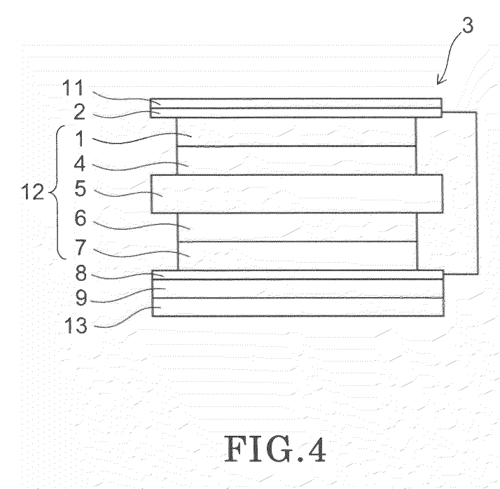

As mentioned later, a direct methanol fuel cell 3 being a kind of fuel cells and using a fuel (methanol) provides methanol to a fuel electrode side to generate reaction between methanol and H₂O on a catalyst layer 6 near a polymer solid electrolyte film 5 as shown in FIG. 4. Accordingly, protons (H⁺) and electrons (e⁻) are produced at the fuel electrode side. In the reaction, H₂O is generated at a catalyst layer 4 of an air electrode (cathode electrode).

Further, generated H₂O penetrates into the gas diffusion layer 1 of the air electrode to attain to gas-liquid equilibrium in the gas diffusion layer 1. Consequently, attaining the gas-liquid equilibrium state leads to coexist between H₂O being liquid and moisture being vapor in the gas diffusion layer 1. Further, oxygen as an oxidization agent entrained from an ambient air is diffused into the gas diffusion layer 1 to attain to the catalyst layer 4. Therefore, holes are configured in the gas diffusion layer 1 for a permeation pass of gas (oxygen).

When liquid H₂O is excess in the gas diffusion layer 1, the holes for the permeation pass of oxygen are infill by liquid H₂O to block penetration of oxygen. Moreover, blocking the penetration of oxygen generates an obstacle against electrochemical reaction as mentioned later so that characteristics of the fuel cell are lowered. Accordingly, transpiration property having transpiration of excess H₂O in the gas diffusion layer 1 is highly demanded.

On the other hand, a part of the generated H₂O at the catalyst layer 4 of the air electrode penetrates into the polymer solid electrolyte film 5 and reacts with methanol on a catalyst layer 6 at a fuel electrode (anode electrode) to generate protons and electrons. On the other hand, as the polymer solid electrolyte film 5 is not suitably wetting, conductivity of proton may be degraded. The transpiration of excess H₂O may generate degradation of characteristics of the fuel cell. Therefore, humidity-retention property is demanded for the gas diffusion layer 1. Actually, it is demanded that the gas diffusion layer 1 suitably retains H₂O to provide H₂O with the fuel electrode side and to suitably wet the polymer solid electrolyte film 5.

Here, a plurality of layers are configured towards a thickness direction of the gas diffusion layer, the layers having different average hole-diameter of the hole. The layer having larger average hole-diameter of the hole retains the transpiration property. On the other hand, the layer having smaller average hole-diameter of the hole retains the humidity-retention property. In the case, the smaller average hole-diameter of the hole is penetrated with H₂O by capillarity to retain the humidity-retention property. However, uniformly forming the average hole-diameter of the hole is difficult. Therefore, retaining H₂O is only dependent on capillarity to lead to an unstable retention amount and humidity-retention property.

According to knowledge obtained by the Applicants, changing wettability in the gas diffusion layers towards the thickness direction can retain suitable transpiration property and humidity-retention property and stabilize the transpiration property and the humidity-retention property.

Accordingly, enhancement of the wettability of the gas diffusion layer 1 strengthens retention of H₂0. Namely, the enhancement of the wettability of the gas diffusion layer 1 leads to improvement of the humidity-retention property. In the case, the enhancement of the retention of H₂O decreases an evaporated H₂O amount to lower the transpiration property. As a result, the enhancement of the wettability of the gas diffusion layer 1 decreases the transpiration property.

Inversely, lowering of the wettability of the gas diffusion layer 1 decreases the retention of H₂O. Consequently, lowering of the wettability of the gas diffusion layer 1 decreases the humidity-retention property. In the case, lowering the retention of H₂O increases evaporated H₂O amount to increase the transpiration property. As a result, lowering wettability of the gas diffusion layer 1 increases the transpiration property.

As mentioned above, intended transpiration property and humidity-retention property can be obtained by suitably selecting the wettability. Furthermore, the wettability can be changed by controlling a surface of a material to be easily uniformized. Consequently, the approach can improve stability as compared to optimizing the transpiration property and the humidity-retention property by changing the average hole-diameter of the hole.

Next, back to FIG. 1, the gas diffusion layer according to the first embodiment of the present invention is further demonstrated as the example. As shown in FIG. 1, a region 1a and a region 1b stacked in layer in the thickness direction of the gas diffusion 1 layer, and the regions 1a and 1b have different wettability each other. The gas diffusion layer 1 is configured on a surface of the catalyst layer at the air electrode side mentioned later and the catalyst layer 4 is configured on a surface of the polymer solid electrolyte film 5.

As mentioned before, intended transpiration property and humidity-retention property can be obtained by suitably selecting the wettability. The transpiration property and the humidity-retention property are optimized by selecting the wettability of the region 1a and the region 1b. In the case, the wettability of the region 1b can be higher than the wettability of the region 1a. For example, enhancing the wettability of the region 1b near the polymer solid electrolyte film 5 and the catalyst layer 6 of the fuel electrode can increase the humidity-retention property in the region 1b by increasing of the retention of H₂O. On the other hand, lowering the wettability of the region 1a near an ambient air can increase the transpiration property in the region 1a by lowering the retention of H₂0. Namely, the wettability in the region 1b configured in the catalyst layer 4 can be higher than the wettability in the region 1a which is supplied oxygen as an oxidization agent.

In this way, H₂O generated near the polymer solid electrolyte film 5 and the catalyst layer 6 of the fuel electrode can be retained. Accordingly, H₂O is efficiently supplied to the polymer solid electrolyte film 5 and the catalyst layer 6 of the fuel electrode. Furthermore, the transpiration can be efficiently carried out as the transpiration property near the ambient air is enhanced. Moreover, suitable transpiration property and humidity-retention property in the gas diffusion layer 1 is totally retained by suitably selecting the wettability in the region 1a and the region 1b. In addition, changing the wettability is explained later.

The generated amount may be largely dependent on a form or an application of the fuel cell. Furthermore, necessary H₂O amount supplied to the fuel electrode side may also be largely dependent on a fuel concentration.

For example, an active type or a passive type is known as a fuel cell. The active type supplying and circulating methanol and oxygen as the fuel by using a pump or a fan can control a generated H₂O amount. On the other hand, the passive type supplying methanol and oxygen as the fuel by utilizing convection, concentration gradient or the like generates comparatively larger H₂O amount because the passive type has not an apparatus controlling the H₂O amount.

Further, higher temperatures in a process may enhance the reaction to generate larger H₂O amount. A higher performance of the air electrode may enhance the reaction to generate larger H₂O amount. In the case of the generated H₂O being larger, the wettability may be changed to enhance the transpiration property. Inversely, in the case of generated H₂O being lower, for example, a lower temperature is used in the process or the air electrode has a lower performance. As the generated H₂O being lower, the wettability may be changed to enhance the humidity-retention property.

When a high concentration of methanol as the fuel is used, H₂O generated in the air electrode is necessary to be supplied to the catalyst layer 6 of the fuel electrode for reaction enhancement in the fuel electrode. Therefore, changing the wettability may enhance the humidity-retention property in this case. On the other hand, when a low concentration of methanol as the fuel is used, providing the H₂O is not so necessary as compared to the high concentration of methanol, because the fuel itself includes H₂O.

As mentioned above, the generated H₂O amount may be largely dependent on the form of the fuel cell, the application circumstance of the fuel cell, the performance of the air electrode or the like. Further, the concentration of methanol or the like as the fuel may change necessary H₂O amount supplied to the fuel electrode side. As a result, combination on the wettability may suitably be changed according to the form and the application of the fuel cell. The example is mentioned above as the wettability in the region 1a is lowered and the wettability in the region 1b is enhanced. However, the wettability in the region 1a may be enhanced and the wettability in the region 1b may be lowered.

As shown in FIG. 1, the two regions are stacked in layer and have different wettability each other. However, an example may not be restricted. A number of regions which are stacked in layer can suitably be changed. Further, boundaries between the regions stacked in layer are not necessary to be clearly. The wettability may be gradually changed, for example, be gradually decreased or be gradually increased. The wettability can be changed in a stepwise manner.

The gas diffusion layer integrated base materials therein, for example, a carbon black or the like, may change wettability of the surface of each base material in an integration direction which is the thickness direction. In the case, the gas diffusion layer is constituted with a plurality of the layers and each of the layers constitutes base material, for example, a carbon black or the like. The wettability may be changed every layer.

A thickness size of the gas diffusion layer 1 is not restricted. The thickness size is summed with sizes of the region 1a and the region 1b. However, the thickness size may be over 20 μm and below 500 μm in consideration with the transpiration property and the humidity-retention property. The base material as the gas diffusion layer 1 can be a carbon black, for example, a channel black, a first black, a lump black, a thermal black, an acetylene black or the like which are carbon fine particles fabricated with industrially-controlled quality. Further, the carbon black may be not restricted as mentioned above but be suitably changed. The base material of the gas diffusion layer 1 may be not restricted as the carbon black but be suitably changed as the carbon fiber or the like, for example.

The wettability can be changed by controlling characteristics of the surface of the base material, the surface of the carbon black. In the case, a material with water repellency is adhered on the surface of the base material, for example, the surface of the carbon black, to change the wettability by an adhesion amount. For example, increasing the adhesion amount of the material with water repellency can increase the water repellency to lower the wettability. On the other hand, decreasing the adhesion amount of the material with water repellency can control enhancement of the water repellency to control lowering the wettability.

A fluorine resin can be shown as the water repellency material, for example. As the fluorine resin, for example, polytetrafluoroethylene (PTFE), tetrafluoroethylene perfluoroalkyl vinyl ether copolymer (PFA), tetrafluoroethylene hexafluoropropylene copolymer (FEP) can be demonstrated. The water repellency material is not as the examples mentioned above but can be suitably changed. Furthermore, controlling characteristics of the surface of the base material is not restricted controlling the adhesion amount of the material with water repellency, for example, surface modification can change the wettability. However, the wettability may be changed by controlling the adhesion amount of the material with water repellency in consideration with production cost, controllability of the wettability or the like.

### Second Embodiment

Next, a gas diffusion layer according to a second embodiment of the present invention is demonstrated as an example. FIG. 2 is a schematic diagram showing the example of the gas diffusion layer according to the second embodiment. As shown in FIG. 2, a region 10a and a region 10b are stacked in layer towards a thickness direction in a gas diffusion layer 10. Each of the two regions has different wettability. The gas diffusion layer 10 on a surface of the catalyst layer 4 in the air electrode (cathode electrode) side as mentioned later. The catalyst layer 4 is configured on a surface of the polymer solid electrolyte film 5. Furthermore, methods for changing the thickness of the gas diffusion layer 10, the base material properties, wettability or the like are the same as the methods for changing the gas diffusion layer 1.

Further, gas permeability of the region 10a and gas permeability of the region 10b is different. Namely, gas permeability of the base material is changed along the integrated direction (thickness direction) in the second embodiment.

Further, suitable transpiration property and humidity-retention property are retained by combining the wettability and the gas permeability in the region 10a and the region 10b. In this way, the transpiration property and the humidity-retention property can be controlled on a basis of the wettability and the gas permeability so that a control region can be extended and a fine control can be performed.

For example, the wettability of the region 10b configured in the side of the catalyst layer 4 can be higher than the wettability of the region 10a in the side which is supplied with oxygen as an oxidization agent. Moreover, the gas permeability of the region 10b configured in the side can be lower than the gas permeability of the region 10a in the side which is supplied with oxygen as the oxidization agent. In this way, the humidity-retention property of the region 10b configured in the side of the catalyst layer 4 can be increased and the transpiration property of the region 10a in the side which is supplied with oxygen as oxidization agent can be increased. However, the combination may be not restricted in the case mentioned above but be suitably changed. Further, a combination of wettability and gas permeability is demonstrated later.

The gas permeability, for example, can be changed by hole sizes formed with integrating the base materials, for example, an average hole-diameter. In the case, increasing the hole size, for example, the average hole-diameter heightens the gas permeability so that the transpiration of generated H₂O can be easily performed to increase the transpiration property. Further, the humidity-retention property is decreased. On the other hand, decreasing the hole size, for example, the average hole-diameter lowers the gas permeability so that the transpiration of generated H₂O can be blocked to decrease the transpiration property. In the case, the humidity-retention property is higher.

The hole size, for example, the average hole-diameter can be changed by modifying, for example, a grain size of the base material such as a grain size of carbon black. In the case, increasing the grain size of the base material increases the hole size, for example, the average hole-diameter. On the other hand, decreasing the grain size of the base material decreases the hole size, for example, the average hole-diameter. Therefore, the hole with intended size, for example, the average hole-diameter can be obtained by suitably changing the grain size of the base material.

For example, when the transpiration property in the region 10a is set to be higher, the grain size of the base material in the region 10a can be between above 2 μm and below 50 μm. When the grain size is over 50 μm, the transpiration property is higher so that suitable humidity-retention property may be not obtained. When the grain size is below 2 μm, humidity-retention property is higher so that suitable humidity-retention property may be not obtained. Furthermore, when the humidity-retention property in the region 10b is set to be higher, the grain size of the base material in the region 10b can be below 2 μm. When the grain size is above 2 μm, the transpiration property is higher so that suitable humidity-retention property may be not obtained.

Further, control of the gas permeability may be not restricted to changing the hole size, for example, the average hole-diameter. When the base material is linear, for example, a carbon fiber or the like, the gas permeability can be changed by a line size of the base material or an interval between the linear base materials. Namely, a method for changing the gas permeability can be suitably changed by a shape or properties of the base material.

Furthermore, decreasing the grain size or the line size of the base material for control of the gas permeability increases a surface area so that more water repellency material can be adhered. Therefore, controllable region of the wettability can be extended.

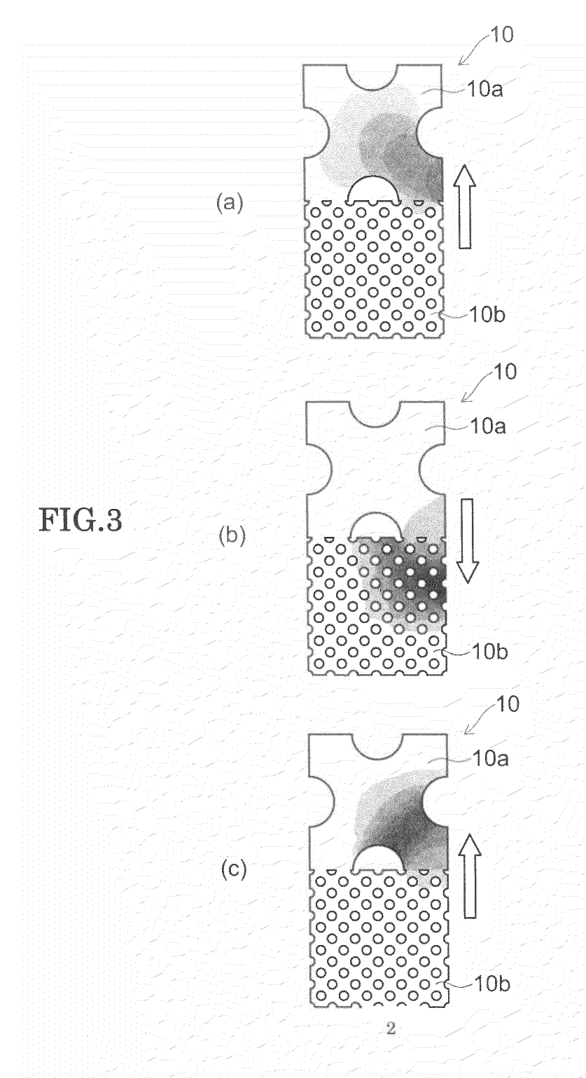

FIGS. 3A, 3B and 3C are schematic diagrams showing examples of controlling transpiration property and humidity-retention property by combination with wettability and gas permeability according to the second embodiment of the present invention. In three figures, an H₂O distribution in the gas diffusion layer 10 is monotonously demonstrated by shading of gray. More dark color means including more H₂O and more light color means including less H₂O. Further, each arrowed line in each figure represents a moving direction.

Furthermore, the base material of the gas diffusion layer 10 is assigned to be the carbon black. The average hole-diameter is modified by changing the grain size to modify the gas permeability. In the case, the grain size of the carbon black formed in the region 10a is 30 μm size and the grain size of the carbon black formed in the region 10b is 6 μm size. A water repellency material is adhered to the carbon black surface. The wettability is modified by the adhesion amount. Moreover, the water repellency material is assigned to be polytetrafluoroethylene (PTFE). The wettability is represented by a contact angle to H₂O.

FIG. 3A shows a case in which contact angles in the region 10a and the region 10b concurrently is 135°. When the contact angle to H₂O being large as 135°, the wettability is decreased and the water repellency is increased to increase the transpiration property. Consequently, generated H₂O in the region 10a is more than generated H₂O in the region 10b. In the case, as the contact angles of the region 10a and the region 10b are the same, influence of the gas permeability becomes larger. As a result, uniformity the grain size and the distribution are easily influenced by carbon black so that a region with generated H₂O and H₂O amount may be unstable.

FIG. 3B shows a case in which contact angles in the region 10a and the region 10b is 135° and 45°, respectively. In the case, the wettability in the region 10a is low and the water repellency in the region 10a is high so that the gas permeability becomes higher. Further, the retention of H₂O by capillarity is weakened. Accordingly, the transpiration property in the region 10a is enhanced. On the other hand, the wettability in the region 10b is high and the water repellency in the region 10b is low so that the gas permeability becomes lower. Further, the retention of H₂O by capillarity is strengthened. Consequently, the humidity-retention property in the region 10b is heightened. The example shown in FIG. 3B is a combination of the wettability and the gas permeability which concurrently have effects on the transpiration property and the humidity-retention property. Accordingly, each effect is summed up, so that the transpiration property in the region 10a is higher and the humidity-retention property in the region 10b is higher.

FIG. 3C shows a case in which contact angles in the region 10a and the region 10b is 45° and 135°, respectively. In the case, the wettability in the region 10a is high and the water repellency in the region 10a is low, so that the gas permeability becomes higher. Further, the retention of H₂O by capillarity is weakened. On the other hand, the wettability in the region 10b is low and the water repellency in the region 10b is high, so that the gas permeability becomes lower. Further, the retention of H₂O by capillarity is strengthened.

The example shown in FIG. 3C is a combination of the wettability and the gas permeability which inversely have effects on the transpiration property and the humidity-retention property, respectively. Consequently, each effect acts to deny each other. In the combination of FIG. 3C, the transpiration property in the region 10b overcomes, so that generated H₂O may be push out to the side of the region 10a.

As mentioned above, controlling the transpiration property and the humidity-retention property only by the average hole-diameter may generate instability of the region being generated H₂O and the H₂O amount. On the other hand, controlling by the combination of the wettability and the gas permeability can stabilize the region being generated H₂O and the H₂O amount.

As shown in FIG. 3B, the wettability and the gas permeability concurrently having the same effect can be combined. On the other hand, as shown in FIG. 3C, the wettability and the gas permeability having the inverse effect can be also combined. As a result, the control region can be widened by suitably combining each effect and each action. Further, the wettability can be changed by controlling characteristics of the material surface to lead to easily control. Therefore, finer control can be performed.

In the FIG. 3C, the two regions are stacked in layer. However, an example is not restricted in the case. A number of the regions stacked in layer can be suitably changed. Further, a boundary between the regions stacked in layer is not necessary to be clearly. The wettability and the gas permeability may be gradually changed.

### Third Embodiment

Next, a fuel cell including the gas diffusion layer according to the third embodiment of the present invention is demonstrated as an example. FIG. 4 is a schematic diagram showing the fuel cell according to the third embodiment. As the example, a direct methanol fuel cell (DMFC) using methanol as the fuel is explained.

As shown in FIG. 4, the fuel cell 3 includes a membrane electrode assembly 12 (MEA) as an electrogenic portion, MEA including a fuel electrode constituted with an catalyst layer 6 and a gas diffusion layer 7, the air electrode constituted with the catalyst layer 4 and the gas diffusion layer 1 and the polymer solid electrolyte film 5 sandwiched between the catalyst layer 6 of the fuel electrode and the catalyst layer 4 of the air electrode according to this embodiment.

The catalyst layer 6 of the fuel electrode may be a material having capability of oxidizing an organic fuel. For example, a kind of a metal at least selecting from iron, nickel, cobalt, tin, ruthenium and gold a fine particle or the like constituted with a platinum solid-solution can be selected.

The catalyst layer 4 of the air electrode may be a material including platinum group element. For example, a single metal such as platinum, ruthenium, rhodium, iridium, osmium, palladium or the like, or a solid-solution with platinum group element can be selected. For example, platinum-nickel or the like is demonstrated as the solid-solution with platinum group element. However, an example is not restricted the case mentioned above but can be suitably changed. Further, a catalyst included in the catalyst layer 6 of the fuel electrode or the catalyst layer 4 of the air electrode may be a supported body with conductivity using a supported catalyst or a non-supported catalyst like carbon materials.

The polymer solid electrolyte film 5 can be demonstrated, for example, a material including a proton conductivity material as a main component. For example, fluorine resin with sulfonate group, for example, perfluorosulfonate polymer, hydrocarbon-group resin with sulfonate group. However, an example is not restricted the case mentioned above but can be suitably changed. In the case, the polymer solid electrolyte film 5 can be, for example, a film with a porous material having through-holes or a film constituted with ceramic having openings, a polymer solid electrolyte material being filled with the through-holes or the openings, a film constituted with a polymer solid electrolyte material.

The gas diffusion layer 7 configured on the surface of the catalyst layer 6 of the fuel electrode roles as uniformly supplying fuel into the catalyst layer 6. Further, the gas diffusion layer 1 configured on the surface of the catalyst layer 4 of the air electrode roles as uniformly supplying oxygen into the catalyst layer 4 and roles as controlling permeation of H₂O generated in the catalyst layer 4, namely, controlling the transpiration property and the humidity-retention property.

The conductive layer 8 stacked in layer is configured in the gas diffusion layer 7 of the fuel electrode, and conductive layer 2 stacked in layer is configured in the gas diffusion layer 1 of the air electrode. The conductive layer 8 and the conductive layer 2 can be constituted with, for example, porous layers such as a mesh constituted with a conductive metal material, for example, gold or the like, or a gold film having openings. Furthermore, the conductive layer 2 and the conductive layer 8 are electrically connected via a load (not illustrated).

The conductive layer 8 in the fuel electrode side is connected to a liquid fuel tank 13 acting as a fuel supply portion via a gas-liquid separation film 9. The gas-liquid separation film 9 only permeates a vaporized component of a liquid fuel and acts as a vapor-phase fuel permeation film not to permeate liquid fuel. The gas-liquid separation film 9 is configured to close openings (not illustrated) of the liquid fuel tank 13 for deriving the vaporized component of the liquid fuel. The gas-liquid separation film 9 separates between the vaporized component of the fuel and the liquid fuel further vaporize the liquid fuel. For example, the gas-liquid separation film 9 is constituted with a material, for example, a silicone rubber.

Furthermore, a permeation controlling film (not illustrated) may be configured at a side of the liquid fuel tank 13 over the gas-liquid separation film 9, the permeation controlling film having a gas-liquid separation function as the same as the gas-liquid separation film 9 and controlling a permeation amount of the vaporized component of the fuel. Controlling the permeation amount of the vaporized component of the fuel by the permeation controlling film can change an opening ratio of the permeation controlling film. The permeation controlling film can be constituted with, for example, a material of polyethylene-terephthalate or the like. Setting the permeation controlling film can lead to the gas-liquid separation of the fuel and controlling a supplying amount of vaporized component of the fuel being supplied to a side of the catalyst layer 6 of the fuel electrode.

In the condition, the liquid fuel stored in the liquid fuel tank 13 can store a methanol solution having over a concentration of 50 mol % or a pure methanol. In the case, the pure methanol can be set over 95 weight % and below 100 weight % as a pure degree. Further, the vaporized component of the liquid fuel means the vaporized methanol, for example when the pure methanol as the liquid fuel. In addition, the vaporized component of the liquid fuel means the mixed vapor with the vaporized component of the methanol and the vaporized component of the H₂O when the methanol solution is used as the liquid fuel.

On the other hand, a cover 11 is set to be stacked on the conductive layer 2 of the air electrode. A plurality of air introducing openings (not illustrated) in the cover 11 are configured for introducing air (oxygen) as an oxidization agent. The cover 11 acts as pressing a film-electrode junction body 12 to increases the adhesion. Therefore, the cover 11 can be formed by a metal, for example, stainless steel such as SUS304.

Next, action of the fuel cell 3 according to the embodiment is demonstrated as an example. The methanol solution (liquid fuel) in the tank 13 is vaporized, the mixed vapor including the vaporized methanol generated by the process and the vapor is permeated in the gas-liquid separation film 9. Further, the mixed vapor passes through the conductive layer 8 and is diffused into the gas diffusion layer 7 to be supplied in the catalyst layer 6. The mixed vapor supplied in the catalyst layer 6 is caused an oxidation reaction according to next equation (1).

CH₃OH+H₂O→CO₂+6H⁺+6e⁻ (1)

On the other hand, when the pure methanol is used as the liquid fuel, the vapor is not supplied from the liquid fuel tank 13 to be caused the oxidation reaction as mentioned equation (1) by H₂O generated in the catalyst layer 4 of the air electrode and the methanol, or H₂O in the polymer solid electrolyte film 5 and the methanol.

In the oxidation reaction as the equation (1) mentioned above, generated protons (H⁺) conducts in the polymer solid electrolyte film 5 to attain to the catalyst layer 4 of the air electrode. In the oxidation reaction as the equation (1) mentioned above, in addition, generated electrons (e⁻) attains from the conductive layer 8 to the catalyst layer 4 via the conductive layer 2 and the gas diffusion layer 1 after being supplied to a load (not illustrated) and working at the load.

Furthermore, oxygen introduced from the air introducing openings in the cover 11 (not illustrated) permeates in the conductive layer 2 and diffuses in the gas diffusion layer 1 to be supplied in the catalyst layer 4. The reaction is caused between the oxygen in the air supplied to the catalyst layer 4, protons attaining at the catalyst layer 4 and electrons attaining at the catalyst layer 4 according to next equation (2) to generate H₂O.

3/2O₂+6H⁺+6e⁻→3H₂O (2)

A part of generated H₂O permeates into the gas diffusion layer 1 to be gas-liquid equilibrium state in the gas diffusion layer 1 of the catalyst layer 4 in the air electrode by the reaction. Furthermore, vaporized H₂O is transpired from the air introducing openings into the cover 11. Further, liquid H₂O is leaved in the catalyst layer 4 of the air electrode.

As mentioned above, providing the gas diffusion layer according to the embodiment can retain the suitable transpiration property and humidity-retention property with respect to a form or an application of the fuel cell. Furthermore, the transpiration property and the humidity-retention property can be stabilized.

When the reaction of equation (2) is preceded, the generated H₂O amount is increased to increase the H₂O amount in the catalyst layer 4 of the air electrode. The H₂O amount in the catalyst layer 4 of the air electrode becomes larger than that in the catalyst layer 6 of the fuel electrode with accompanying the reaction process in the equation (2). As a result, H₂O generated in the catalyst layer 4 of the air electrode passes through the polymer solid electrolyte film 5 to move to the catalyst layer 6 of the fuel electrode by osmotic pressure. Consequently, supplying H₂O is proceeded to enhance the reaction of the equation (1) as compared to be dependent only on the vapor vaporized from the liquid fuel tank 13 supplying H₂O to the catalyst layer 6 of the fuel electrode. In this way, output density can be increased and the high output density can be retained for a long period.

When the methanol concentration as the liquid fuel is 50 mol % solution or pure methanol, H₂O moved from the catalyst layer 6 of the fuel electrode to the catalyst layer 4 of the air electrode can be used as the reaction of the equation (1) as mentioned above. Further, the reaction of the equation (1) as mentioned above can lowered the reaction, so that a long term output characteristic and a load electrical current characteristic can be improved. Further, the liquid fuel tank 13 can be planned to minimize a size. The polymer solid electrolyte film 5 can be wetting so that higher conductive protons (H⁺) can also obtained.

Providing the gas diffusion layer according to the embodiment can optimize the moving of H₂O. The gas diffusion layer can include the suitable transpiration property and the humidity-retention property so that the generated H₂O can be efficiently supplied to the catalyst layer 6 of the fuel electrode and can be efficiently transpired excess H₂O. Accordingly, the suitable transpiration property and humidity-retention property can be retained according to the embodiment. Furthermore, the gas diffusion layer, the fuel cell and a method for fabricating the fuel cell are provided to stabilize the transpiration property and the humidity-retention property.

### Fourth Embodiment

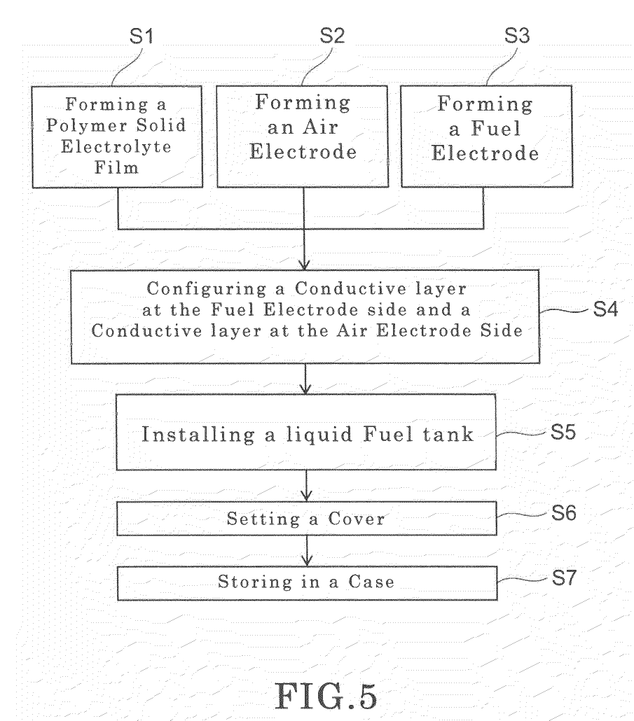

Next, a method for fabricating the fuel cell according to the fourth embodiment of the present invention is demonstrated as an example. FIG. 5 is a flowchart of the method for fabricating the fuel cell according to the fourth embodiment of the present invention.

First, a porous material film is formed by a chemical or physical method, for example, phase separation method, foam formation method, sol-gel method or the like. A commercial porous material is suitably used as the porous material film may. For example, a polyimide porous film having a thickness of 25 μm and an opening ratio of 45%, such as UPILEX™ (Ube Industries, Ltd.) or the like can be used. A polymer solid electrolyte is filled into the porous material film to form the polymer solid electrolyte film 5 (step S1). As a method for filling the polymer solid electrolyte, the porous material film is immersed in an electrolyte solution, subsequently the porous material film is pulled up and dried to remove the solvent, for example. As the electrolyte solution, Nafion™ (Du Pont Corporation) solution is demonstrated for example. The polymer solid electrolyte film 5 may be a film constituted with a polymer electrolyte material. In the case, forming the porous material film or filling the polymer solid electrolyte is unnecessary.

Next, fine particles of platinum, particle or fiber carbon, for example, active carbon, graphite or the like and a solution are mixed to be a paste. The paste is dried at room temperature so that the catalyst layer 4 of the air electrode is formed. Furthermore, the gas diffusion layer is formed on a surface of the catalyst layer 4 to constitute the air electrode according to the embodiment (step S2).

The method for fabricating the gas diffusion layer according to the embodiment is further demonstrated, for example. First, a base material having prescribed size, for example, a carbon black having prescribed grain size is dispersed in polytetrafluoroethylene (PTFE) or the like which includes a water repellency material and a solution containing water and alcohol solvent to generate a mixed solution.

The base material size is selected in consideration with transpiration property and humidity-retention property to determine a contain amount of PTFE or the like which is the water repellency material. For example, when the transpiration property is heightened, a larger base material is selected in a prescribed range and a contain amount of PTFE or the like which is the water repellency material becomes larger. When the humidity-retention property is heightened, a smaller base material is selected in a prescribed range and a contain amount of PTFE or the like which is the water repellency material becomes smaller.

In the case mentioned above, the transpiration property and the humidity-retention property are controlled by combination of the wettability and the gas permeability. When the transpiration property and the humidity-retention property are controlled by changing the wettability in the case of the gas diffusion layer 1, an amount of PTFE or the like which is the water repellency material may be changed.

Next, the mixed solution is coated on the surface of the catalyst layer 4 of the air electrode and is dried to form the gas diffusion layer. In the processing step, various base material sizes or various amounts of PTFE or the like which is the water repellency material are prepared and coated in order to obtain necessary transpiration property and humidity-retention property. When the wettability or the gas permeability are gradually modified, the base material sizes or the various amounts of PTFE or the like, which are the water repellency material, may be prepared and coated in changing the parameters little by little. When the wettability and the gas permeability are changed in stepwise, the base material sizes or the various amounts of PTFE or the like, which are the water repellency material, may be prepared and coated in changing the parameters in stepwise. Namely, the wettability of the surface of the base material in the thickness direction of the gas diffusion layer may be changed by modifying the amount of PTFE or the like which are the water repellency material. The gas permeability in the thickness direction of the gas diffusion layer may be changed by modifying the base material size. Coating and drying can be repeated as multiple steps.

On the other hand, fine particles of platinum-nickel solid-solution, particle or fiber carbon, for example, active carbon, graphite or the like and a solution are mixed to be a paste. The paste is dried at room temperature so that the catalyst layer 6 of the fuel electrode is formed. The gas diffusion layer 7 on the surface of the catalyst layer 6 is formed to constitute the fuel electrode (step S3). The carbon black having the grain of 1.0 μm size, for example, is dispersed in a solution containing water and alcohol solvent to generate a mixed solution. The gas diffusion layer 7 can be formed by coating and drying the mixed solution on the surface of the catalyst layer 6.

Next, the film-electrode junction body 12 is formed by the polymer solid electrolyte film 5, the air electrode (the catalyst layer 4 and the gas diffusion layer 1) and the fuel electrode (the catalyst layer 6 and the gas diffusion layer 7). The conductive layer 8 and the conductive layer 2 are configured to sandwich the film-electrode junction body 12 (step S4). The conductive layer 8 and the conductive layer 2 are constituted with a gold foil or the like including a plurality of openings for introducing the vaporized methanol or air.

Next, a liquid fuel tank 13 is installed on the conductive layer 8 via the gas-liquid separation film 9 (step S5). A silicone sheet, for example, can be used as the gas-liquid separation film 9.

Next, the cover 11 is set on the conductive layer 2 (step S6). The cover 11 can be, for example, a stainless steel sheet (SUS304) in which the air introducing openings are formed (not illustrated) for introducing the air. Finally, the fuel cell 3 is stored in a suitable case to complete the fabricating processes (step S7).

Other embodiments of the present invention will be apparent to those skilled in the art from consideration of the specification and practice of the invention disclosed herein. It is intended that the specification and example embodiments be considered as exemplary only, with a true scope and spirit of the invention being demonstrated by the claims that follow. The invention can be carried out by being variously modified within a range not deviated from the gist of the invention.

For example, a shape, a size, material properties, design or the like of each element in the fuel cell as mentioned before are not restricted as the examples but can be suitably changed. The example as the fuel is methanol, however, that is not restricted. As another fuel other than methanol; ethanol, propanol or the like as alcohol group, dimethyl ether or the like as ether group, cyclohexane as cycloparaffin group, hydroxyl group, carboxyl group, amino group, amide group or the like as cycloparaffin group having hydrophilic group. The fuels mentioned above are conventionally used as a solution with 5-90 weight %.

What is claimed is:

1. A gas diffusion layer, comprising:
base materials integrated being including in the gas diffusion layer configured in an air electrode, wettability of a surface of each base material changing in an integrated direction.

2. The gas diffusion layer according to claim 1, further comprising:
a water-repellent material adhered on the surface of the base material, the wettability of the surface of the base material being changed by an adhesion amount of the water-repellent material.

3. The gas diffusion layer according to claim 1, wherein
the base material has a plurality of layers, wettability of each of the layer changes.

4. The gas diffusion layer according to claim 1, wherein
wettability of a surface of the gas diffusion layer at a side of a catalyst layer is higher than wettability of a surface of gas diffusion layer at a side being supplied an oxidization agent.

5. The gas diffusion layer according to claim 1, wherein
gas permeability of the base material changes in the integrated direction.

6. The gas diffusion layer according to claim 5, wherein
the base material includes holes, the gas permeability of the base material is changed by a hole size.

7. The gas diffusion layer according to claim 5, wherein
gas permeability of the surface of the gas diffusion layer at the side of the catalyst layer is higher than gas permeability of the surface of the gas diffusion layer at the side being supplied the oxidization agent.

8. The gas diffusion layer according to claim 1, wherein
the wettability is evaluated by a contact angle to water.

9. The gas diffusion layer according to claim 1, wherein
a function of the gas diffusion layer is controlled by the wettability and the gas permeability of the gas diffusion layer.

10. A fuel cell, comprising:
a fuel cell electrode provided a fuel;
an air electrode provided an oxidization agent, the air electrode including a gas diffusion layer, the gas diffusion layer including base materials integrated, wettability of a surface of each base material changing in an integrated direction; and
a polymer solid electrolyte film sandwiched between the fuel cell electrode and the air electrode.

11. The fuel cell according to claim 10, further comprising:
a water-repellent material adhered on the surface of the base material, the wettability of the surface of the base materials being changed by an adhesion amount of the water-repellent material.

12. The fuel cell according to claim 10, wherein
the base material has a plurality of layers, wettability of each of the layers changes.

13. The fuel cell according to claim 10, wherein
wettability of a surface of the gas diffusion layer at a side of a catalyst layer is higher than wettability of a surface of gas diffusion layer at a side being supplied the oxidization agent.

14. The fuel cell according to claim 10, wherein
gas permeability of the base material changes in the integrated direction.

15. The fuel cell according to claim 14, wherein
the base material includes holes, the gas permeability of the base material is changed by hole sizes.

16. The fuel cell according to claim 14, wherein
gas permeability of the surface of the gas diffusion layer at the side of the catalyst layer is higher than gas permeability of the surface of the gas diffusion layer at the side being supplied the oxidization agent.

17. The fuel cell according to claim 10, wherein
the wettability is evaluated by a contact angle to water.

18. The fuel cell according to claim 10, wherein
a function of the gas diffusion layer is controlled by the wettability and the gas permeability of the gas diffusion layer.

19. A method for fabricating a fuel cell, comprising;
dispersing base materials in a solvent with water and alcohol-group including a water-repellent material to generate a mixed solution; and
coating the mixed solution on a catalyst layer and drying the mixed solution to form a gas diffusion layer;
wherein wettability of a surface of each base material in a thickness direction is changed by changing an amount of the water-repellent material.

20. The method for fabricating the fuel cell according to claim 19, wherein
gas permeability of the base material in the thickness direction is changed by changing a base material size.
